(19) United States
(12) Patent Application Publication
(10) Pub. No.: US 2026/0088320 A1
(43) Pub. Date: Mar. 26, 2026

(54) SYSTEM FOR A DUAL INPUT FUEL CELL

(71) Applicant: Caterpillar Inc., Peoria, IL (US)

(72) Inventors: Ravinder Das Mahajan, Bloomington, IL (US); David Andrew Pierpont, Dunlap, IL (US)

(73) Assignee: Caterpillar Inc., Peoria, IL (US)

(21) Appl. No.: 18/892,793

(22) Filed: Sep. 23, 2024

(51) Int. Cl. H01M 8/04992; B60R 16/03; H01M 8/04082; H01M 8/04111; H01M 8/04746; H01M 8/0612; H01M 8/0662

(52) U.S. Cl. CPC H01M 8/04992; H01M 8/04111; H01M 8/04201; H01M 8/04753; H01M 8/0618; H01M 8/0662; B60R 16/03; H01M 2250/20

(57) ABSTRACT

Provided herein are systems and methods for using a dual input in a fuel cell. A vehicle may include a fuel cell, a first storage, a second storage, a plurality of valves, and a processing circuit. The fuel cell includes an anode loop configured to receive hydrogen, and the plurality of valves are respectively fluidically coupled between the anode loop and at least one of the first storage or the second storage. The processing circuit may determine a type of fuel to be supplied to the anode loop, from a first type stored in the first storage and a second type stored in the second storage. The processing circuit may also generate control signals for the plurality of valves to control fluid flow from a respective storage of the first storage and the second storage, based on the type of fuel, to supply hydrogen to the anode loop.

### TECHNICAL FIELD

The present invention relates generally to the field of fuel cells, including but not limited to a system for a dual input fuel cell.

### BACKGROUND

A fuel cell typically generates electricity by combining hydrogen and oxygen in an electrochemical reaction. Hydrogen atoms enter the fuel cell at the anode, where they are split into protons and electrons; the protons move through the electrolyte to the cathode, while the electrons travel through an external circuit, creating an electric current, and at the cathode, they combine with oxygen to form water as a byproduct. Fuel cells thus rely on hydrogen (H₂) for operation, and can receive the H₂ from a variety of sources. In some instances, because methanol contains hydrogen, a methanol solution can be a source of H₂ for a fuel cell, in addition to a pure hydrogen solution.

For example, U.S. Pat. No. 11,896,487 describes a flexible fuel cell system configuration to handle multiple fuels. Such a flexible fuel cell system includes a fuel cell system and a fuel source that supplies a plurality of fuels. The fuel cell system uses the plurality of fuels and can execute a transition to switch from one fuel to another.

### SUMMARY

A first aspect provided herein relates to a vehicle including a fuel cell, a first storage configured to store a first type of fuel, a second storage configured to store a second type of fuel, a plurality of valves, and a processing circuit. The fuel cell includes an anode loop configured to receive hydrogen, and the plurality of valves are respectively fluidically coupled between the anode loop and at least one of the first storage or the second storage. The processing circuit includes one or more processors and memory, the memory storing instructions that, when executed, cause the processing circuit to determine a type of fuel to be supplied to the anode loop, from the first type and the second type. The instructions also cause the processing circuit to generate one or more control signals for the plurality of valves to control fluid flow from a respective storage of the first storage and the second storage, based on the type of fuel, to supply hydrogen to the anode loop.

A second aspect provided herein relates to an energy system for a vehicle including a fuel cell, a first storage configured to store a first type of fuel, a second storage configured to store a second type of fuel, a plurality of valves, and a processing circuit. The fuel cell includes an anode loop configured to receive hydrogen, and the plurality of valves are respectively fluidically coupled between the anode loop and at least one of the first storage or the second storage. The processing circuit includes one or more processors and memory, the memory storing instructions that, when executed, cause the processing circuit to determine a type of fuel to be supplied to the anode loop, from the first type and the second type. The instructions also cause the processing circuit to generate one or more control signals for the plurality of valves to control fluid flow from a respective storage of the first storage and the second storage, based on the type of fuel, to supply hydrogen to the anode loop.

A third aspect provided herein relates to a method of using a first type of fuel and a second type of fuel in a fuel cell, the method including determining, by a processing circuit, a type of fuel to be supplied to an anode loop of a fuel cell from a first type of fuel stored in a first storage and a second type of fuel stored in a second storage; and generating, by the processing circuit, one or more control signals for a plurality of valves to control fluid flow from a respective storage of the first storage and the second storage, based on the type of fuel, to supply hydrogen to the anode loop.

### BRIEF DESCRIPTION OF THE DRAWINGS

FIG. 1 is a block diagram of a system for a dual input fuel cell, according to an embodiment of the present disclosure;

FIG. 2 is a schematic diagram of anode and cathode loops of a fuel cell system, according to an embodiment of the present disclosure;

FIG. 3 is a schematic diagram of coolant and high voltage loops of a fuel cell system, according to an embodiment of the present disclosure;

FIG. 4 is a schematic diagram of the anode and cathode loops of the fuel cell system of FIG. 2 in a pure hydrogen mode, according to an embodiment of the present disclosure;

FIG. 5 is a schematic diagram of the coolant and high voltage loops of the fuel cell system of FIG. 3 in a pure hydrogen mode, according to an embodiment of the present disclosure;

FIG. 6 is a schematic diagram of the anode and cathode loops of the fuel cell system of FIG. 2 in a methanol mode, according to an embodiment of the present disclosure;

FIG. 7 is a schematic diagram of the coolant and high voltage loops of the fuel cell system of FIG. 3 in a methanol mode, according to an embodiment of the present disclosure;

FIG. 8 is a schematic diagram of the anode and cathode loops of the fuel cell system of FIG. 2 in a dual input mode, according to an embodiment of the present disclosure;

FIG. 9 is a flowchart showing a method of operation of a dual input fuel cell, according to an embodiment of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, the systems and methods described herein may be configured, designed, or otherwise arranged to utilize two types of fuel (e.g., a methanol solution and/or a pure hydrogen fuel) in a turbocharged fuel cell. High temperature (HT)-proton exchange membrane (PEM) fuel cells a type of fuel cell which operates between and 160° C. and 200° C. These HT-PEM fuel cells offer several benefits over low temperature (LT)-PEM fuel cells, which operate around 70° C. For example, for use in stationary/slow-moving machinery, an HT-PEM fuel cell may be preferable to an LT-PEM fuel cell, as the machinery has limited cooling system capacity and the higher coolant operating temperature of HT-PEM fuel cell systems may facilitate a higher heat rejection potential. Despite their benefits, however, a drawback of an HT-PEM fuel cell is a lower efficiency and power density as compared to an LT-PEM fuel cell.

To close the gap on efficiency and power density between HT-PEM and LT-PEM fuel cell stack technologies, the fuel cell system as described herein includes a turbocharger to improve the gross stack efficiency and power density. The turbocharger may be used to increase the pressure of the cathode and anode loops of the fuel cell system, which increases stack efficiency and power output. Additionally, the turbocharger recovers exhaust heat energy through an expander stage. The cathode side (e.g., the air side) of the stack releases exhaust at a temperature between 160° C. and 200° C., and excess hydrogen exits the anode side (e.g., the fuel side) of the stack.

Different fuel cell systems available are designed to work with either hydrogen or methanol as a fuel, based on their end use. For fuel cell systems designed to work with hydrogen fuel alone, however, low volume, high development costs, limited hydrogen availability, and high hydrogen cost may contribute to high product and operating costs, resulting in a low adoption rate for such fuel cell systems. Therefore, fuel cell systems may benefit from a design configured to operate using an alternative fuel source, such as methanol, that still provides the hydrogen for operation of the fuel cell system. A dual fuel HT-PEM fuel cell system, which works with both hydrogen and methanol, may support multiple applications with modular product design, potentially leading to higher product volumes and lower costs. The dual fuel option may provide customers the flexibility to use the fuel that is most easily and economically available. The low cost and high density of methanol may make fuel cells a viable option for customers today, while providing opportunities to switch to hydrogen at a later date, based on changes in hydrogen-supply/availability.

Additionally, the systems and methods described herein provide for reuse of exhaust energy in the system, leading to higher overall efficiency compared to other implementations of HT-PEM systems. That is, according to the fuel cell system described herein, the excess hydrogen from the anode side may be combined with excess oxygen from the cathode side and routed through a hydrogen catalytic converter. The hydrogen catalytic converter releases the hydrogen energy and increases the exhaust temperature to a temperature between 200° C. and 300° C. The dual fuel HT-PEM fuel cell system, as described herein, improves power-density by including a turbocharger with a compressor, a turbine, and an electric (or e-) motor in the fuel cell system. The compressor provides compressed air for maintaining desired fuel cell inlet conditions, while the turbine recovers excess energy from the high-temperature cathode exhaust gases of the fuel cell. In order to utilize the methanol solution as fuel, the fuel cell system may include a reformer to convert the methanol solution to hydrogen prior to entering the fuel cell stack. Therefore, in the fuel cell system as described herein, the reformer uses the high-temperature exhaust gas released by the hydrogen catalytic converter as a heat source, which reduces emissions from the fuel cell and improves operational efficiency. The expander stage of the turbocharger recovers remaining heat from the reformer, thus achieving maximum efficiency. Additional aspects of the present disclosure, as well as additional benefits of the present solution, are described in greater detail below.

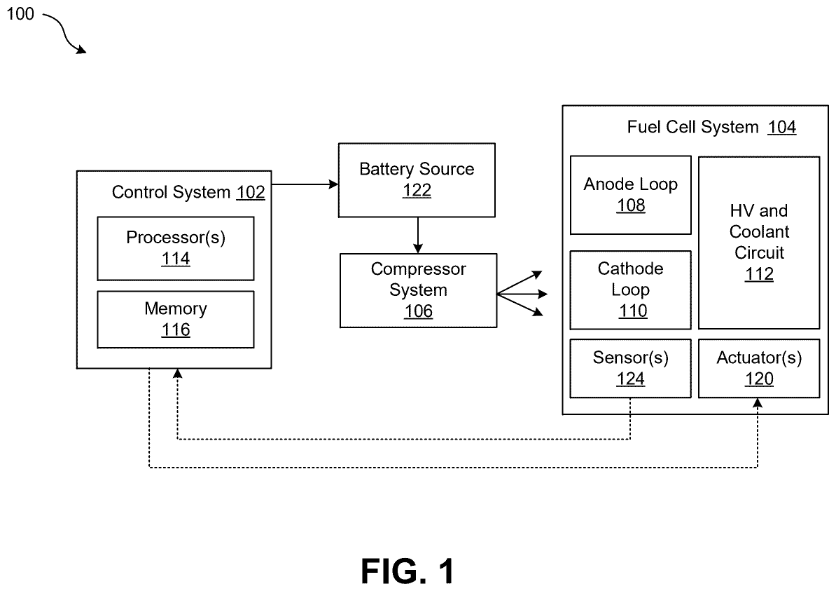

Referring now to FIG. 1, depicted is a block diagram of a system 100 for a dual input fuel cell, according to an example implementation of the present disclosure. The system 100 may include a control system 102 communicably coupled to a fuel cell system 104 and a compressor system 106. The system 100 may be implemented in various environments or systems. For example, the system 100 may be implemented in various vehicles for supplying power to the vehicle, as a power generation system for homes or businesses (e.g., primary or back-up power), etc. In some embodiments, the system 100 may be implemented in various heavy machinery components or vehicles to supply power thereto. As described in greater detail below, the control system 102 may be configured to detect, determine, or otherwise identify a type of fuel (e.g., input) used in the fuel cell system 104, and generate one or more control signals to control a fluid flow (e.g., within the fuel cell system 104) based on the type of fuel used in the fuel cell system 104.

The fuel cell system 104 may include various types or forms of fuel cells. In some embodiments, the fuel cell system 104 may be or include a proton exchange membrane (PEM) fuel cell. For example, the fuel cell system 104 may be or include a high temperature PEM (HT-PEM) fuel cell (e.g., a fuel cell which operates at high temperatures at fully warm conditions, such as 160° C.) or a low temperature PEM (LT-PEM) fuel cell (e.g., a fuel cell which operates at low temperatures [relative to HT-PEM fuel cells] at fully warm conditions, such as 70° C.). In various embodiments, the fuel cell system 104 may include other types of fuel cells, such as solid oxide fuel cells (SOFCs), molten carbonate fuel cells (MCFCs), alkaline fuel cells (AFCs), phosphoric acid fuel cells (PAFCs), and/or direct methanol fuel cells (DMFCs).

The fuel cell system 104 may include an anode loop 108, a cathode loop 110, and a high voltage (HV) and coolant circuit 112. As described in greater detail below, the anode loop 108 may be configured to be supplied with hydrogen. The cathode loop 110 may be supplied with oxygen. The anode loop 108 and cathode loop 110 may supply the hydrogen and oxygen to a PEM, which converts the hydrogen into protons and electrons, the protons interacting with the oxygen for producing heat and water, and the electrons supplied as power (e.g., electricity).

The control system 102 may include one or more processors 114 and memory 116. The processor(s) 114 may be or include any device, component, element, or hardware designed or configured to perform the various steps recited herein. For example, the processor(s) 114 may include any number of general purpose single- or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. In some embodiments, the control system 102 may include a single processor 114 designed or configured to perform each of the various steps recited herein. In some embodiments, the control system 102 may include multiple processors 114 which are designed or configured to perform (e.g., either separately or together) each of the various steps recited herein. As one example, the control system 102 may include a first processor 114 designed or configured to perform a first subset of the various steps, and a second processor 114 designed or configured to perform a second subset of the various steps (with the first subset being different from the second subset). As another example, the control system 102 may include first and second processors 114 which together perform the various steps in a distributed fashion. As such, unless explicitly indicated otherwise, such as by use of a term such as “a single processor”, the term “one or more processor(s)” as used herein contemplates and encompasses embodiments in which all of the one or more processors perform all of the recited steps or features, different processors separately perform different ones of the steps or features, the same or different sets of two or more processors work in combination to perform individual steps or features, or any variation thereof. In other words, unless explicitly indicated otherwise, the use of the term “one or more processors” herein contemplates and encompasses a single processor performing all of the recited steps or features and two or more processors working individually or in combination, where each step or feature is performed by any one or combination of two or more of the processors. The memory 116 may be or include any type or form of data storage device, including tangible, non-transient volatile memory and/or non-volatile memory.

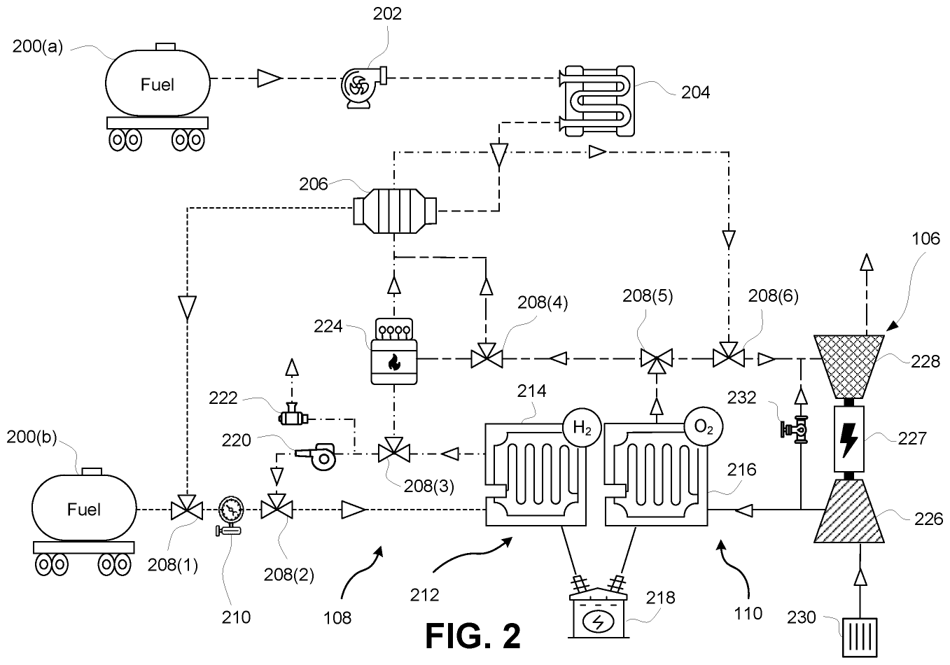

Referring now to FIG. 1 and FIG. 2, the fuel cell system 104 may include the anode loop 108 and the cathode loop 110. Specifically, FIG. 2 is a schematic diagram of anode and cathode loops 108, 110 of the fuel cell system 104, according to an embodiment of the present disclosure.

As shown in FIG. 2, the anode loop 108 may include a first storage 200(a) and a second storage 200(b). The first storage 200(a) may be configured to store a first type of fuel, while the second storage 200(b) may be configured to storage a second type of fuel. In some embodiments, the first type of fuel includes a methanol fuel (e.g., a methanol solution) and the second type of fuel includes a hydrogen fuel (e.g., a pure hydrogen solution). The first storage 200(a) may be communicably coupled to a fuel pump 202. The fuel pump 202 may be configured to pump the first type of fuel from the first storage 200(a) such that the first type of fuel may flow through the anode loop 108. The first storage 200(a) may be further configured to supply or otherwise provide the first type of fuel (e.g., the methanol solution) to a reformer 206 through the fuel pump 202.

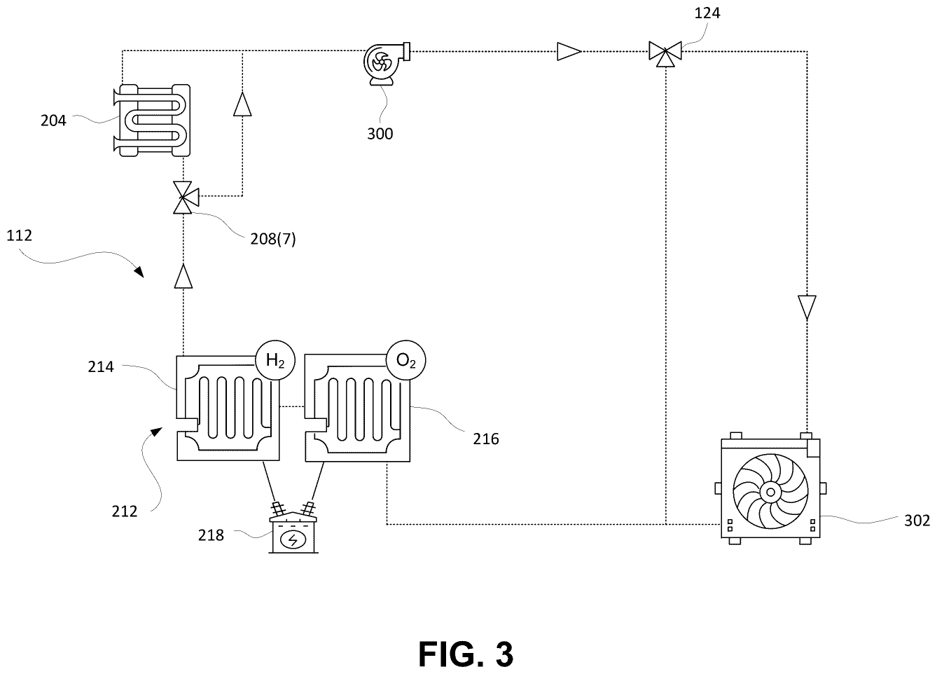

In some embodiments, a vaporizer 204 may be arranged between the first storage 200(a) and the reformer 206. The vaporizer 204 may be configured to receive the fuel from the first storage 200(a), to supply to the reformer 206. The vaporizer 204 may be configured to vaporize the first type of fuel received from the first storage 200(a) such that the first type of fuel supplied to the reformer 206 is a gaseous/vaporized fuel. For example, in some embodiments, the first storage 200(a) is configured to store the first type of fuel in a liquid state (e.g., a methanol and water solution). Therefore, the vaporizer 204 receives the first type of fuel in the liquid state and is configured to vaporize the first type of fuel from the liquid state to a gaseous state. In some embodiments, as described below with reference to FIG. 3, the vaporizer 204 may be arranged within the HV and coolant circuit 112 such that the HV and coolant circuit 112 is heated by excess heat provided by the vaporizer 204.

The reformer 206 may receive the first type of fuel from the first storage 200(a). The reformer 206 may be configured to produce hydrogen from the received first type of fuel (e.g., methanol). In some embodiments, the reformer 206 may be coupled to the vaporizer 204 such that the reformer 206 receives the gaseous fuel from the vaporizer 204. In such embodiments, the reformer 206 may be configured to extract the hydrogen from the gaseous state of the first type of fuel. The reformer 206 may also produce excess heat that may be provided to an expander 226 (e.g., via a flow control valve 208(6), as described herein).

Referring to FIG. 1, the fuel cell system 104 may include various actuators 120. The actuators 120 may include pumps, valves, regulators, diverters, or any other actuators designed or configured to control the flow of a fluid. For instance, the anode loop 108 may include various actuators 120 (e.g., flow control valves 208(1), 208(2), pressure regulator 210) for controlling the flow of hydrogen to the anode catalyst 214. Similarly, the cathode loop 110 may include various actuators 120 (e.g., flow control valves 208(5), 208(4)) for regulating the flow of air to or from the cathode catalyst 216. The cathode loop 110 may also include an air filter 230 arranged at an inlet to the cathode loop 110, to filter air prior to entering the cathode loop 110. Additionally, as described in greater detail below with reference to FIG. 3, the HV and coolant circuit 112 may include various actuators 120 for controlling the flow of coolant. For example, the HV and coolant circuit 112 may include a flow control valve 208(7), a pump 300, and a thermostat 124 with an included actuator, for controlling the flow of coolant through the coolant circuit 112.

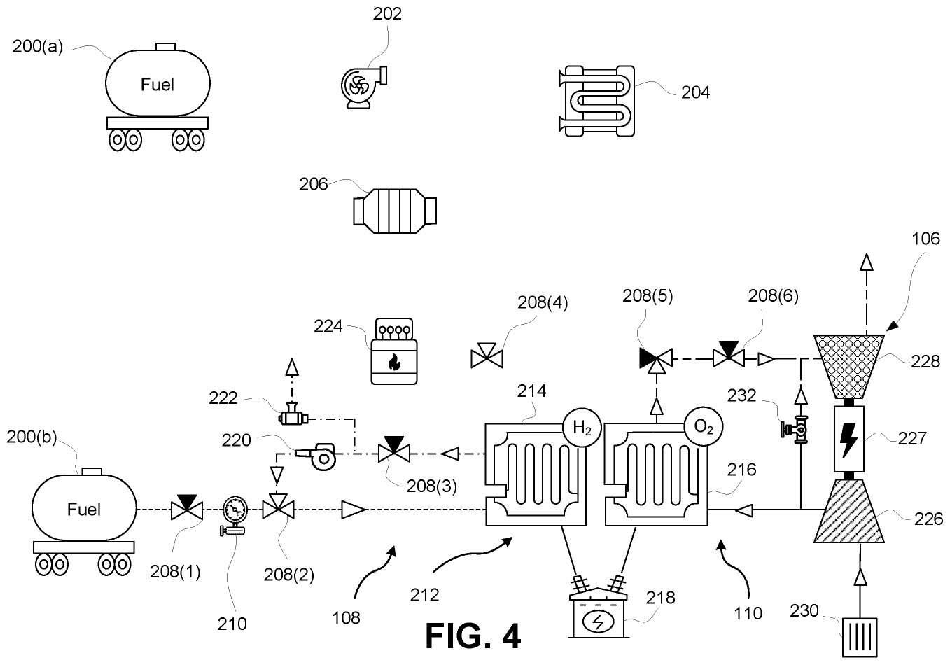

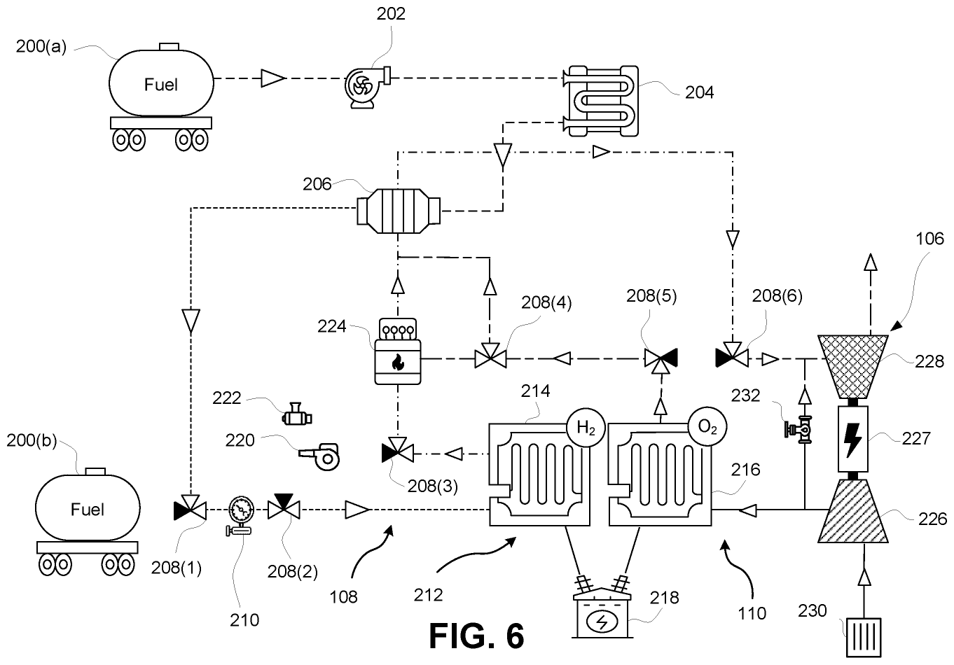

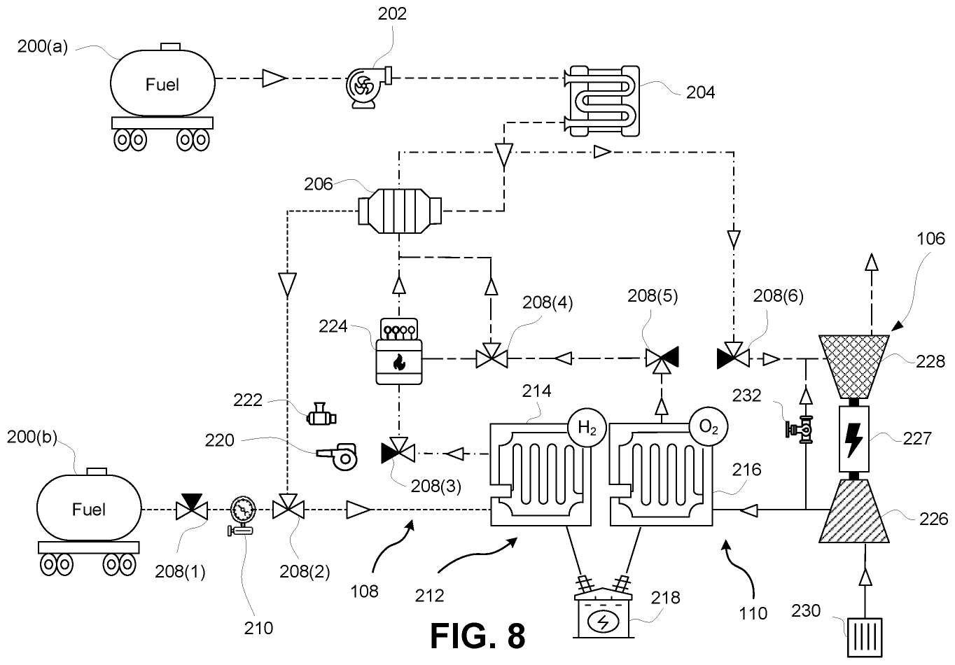

As shown in FIG. 2, the second storage 200b may be communicably coupled to a flow control valve 208(1). The flow control valve 208(1) may be a single flow control valve of a plurality of flow control valves included in the fuel cell system 104 that are fluidically coupled between the anode loop 108 and at least one of the first storage 200(a) or the second storage 200(b). Specifically, the control system 102 may control the flow control valve 208(1) such that the second type of fuel stored in the second storage 200(b) may be supplied to the anode loop 108 (e.g., when the flow control valve 208(1) is in an open position, as described below with reference to FIGS. 4 and 8) or may be prevented from being suppplied to the anode loop 108 (e.g., when the flow control valve 208(1) is in a closed position, as described below with reference to FIG. 6).

The second storage 200(b) may also be communicably coupled to a pressure regulator 210. That is, the second storage 200(b) may be configured to supply or otherwise provide hydrogen (e.g., H₂) to the pressure regulator 210 (e.g., through the flow control valve 208(1)). The pressure regulator 210 may be configured to increase, decrease, or otherwise regulate the supplied hydrogen from the second storage 200(b), for supply to a proton exchange membrane (PEM) 212. Specifically, the pressure regulator 210 may be configured to supply the pressurized hydrogen to an anode catalyst 214 of the PEM 212 through a flow control valve 208(2). The cathode loop 110 may have air (e.g., ambient air) supplied thereto. Specifically, oxygen from the ambient air may be supplied to a cathode catalyst 216 of the PEM 212. Together, the hydrogen supplied to the anode catalyst 214 and oxygen supplied to the cathode catalyst 216 may operate to produce electrical energy and heat for the fuel cell. More specifically, the hydrogen may be split into protons and electrons at the anode catalyst 214, and the oxygen may combine with the protons and electrons to produce electricity and water, with heat generated as a byproduct. The electrons may flow to an electrical power circuit 218 (e.g., a high-voltage bus) to generate electrical power, while the protons may move through the PEM 212 to facilitate the electrochemical reactions for producing the water and heat. As shown in FIG. 2, a flow control valve 208(3) may be used to feed diluted hydrogen back into the anode loop 108 via a hydrogen compressor 220, as well as out of the system 100 as exhaust via an exhaust valve 222. In some embodiments, the flow control valve 208(3) may be used to direct excess hydrogen from the anode catalyst 214 to a catalytic converter 224.

The anode catalyst 214 may release excess hydrogen, while the cathode catalyst 216 may release excess oxygen. The anode catalyst 214 and cathode catalyst 216 may release excess hydrogen and oxygen, respectively, at a high temperature. A catalytic converter 224 may receive the excess hydrogen from the anode catalyst 214 through the flow control valve 208(3) and the excess oxygen from the cathode catalyst 216 through flow control valves 208(4), 208(5) such that excess exhaust from the PEM 212 may be fed back into the anode loop 108. The catalytic converter 224 may be configured to release heat (e.g., hydrogen energy) from the excess hydrogen received from the anode catalyst 214. The released heat from the catalytic converter 224 may be at a high temperature (e.g., between 200° C. and 300° C.), and may be used as a heat source to power the reformer 206.

As shown in FIG. 2, the cathode loop 110 may include flow control valves 208(4), 208(5), and 208(6). The flow control valve 208(5) may be coupled to the cathode catalyst 216 and may be used to control a flow of the exhaust (e.g., the excess oxygen) from the cathode catalyst 216. In some embodiments, where methanol (e.g., fuel stored in the first storage 200(a)) is used to operate the fuel cell system 104 (e.g., as shown in the methanol mode of FIG. 6 and/or the dual input mode of FIG. 8), the flow control valve 208(5) may direct exhaust from the cathode catalyst 216 through the flow control valve 208(4), and not through the flow control valve 208(6). The flow control valve 208(4) may be configured to route the exhaust from the cathode catalyst 216 to the catalytic converter 224 and/or around the catalytic converter 224 (e.g., directly to the reformer 206). For example, the flow control valve 208(4) may control an air-fuel ratio in the catalytic converter 224 by directing the exhaust from the cathode catalyst 216 to the catalytic converter 224 when the air-fuel ratio is low and by directing the exhaust from the cathode catalyst 216 around the catalytic converter 224 when the air-fuel ratio is high. In some embodiments where only hydrogen (e.g., fuel stored in the second storage 200(b)) is used to operate the fuel cell system 104 (e.g., as shown in the pure hydrogen mode of FIG. 4), the flow control valve 208(5) may direct exhaust from the cathode catalyst 216 through the flow control valve 208(6), and not through the flow control valve 208(4). The flow control valve 208(6) may be configured to route the exhaust from the cathode catalyst 216 to the compressor system 106.

Referring to FIG. 1 and FIG. 2, the system 100 may include the compressor system 106. In various embodiments, the compressor system 106 may be or include a turbo compressor system. The compressor system 106 may be communicably coupled to the control system 102 and the fuel cell system 104, and may be powered by a battery source 122. In this regard, the compressor system 106 may be or include an eTurbo (e.g., an electric turbo) compressor system. The battery source 122 may be an external battery source separate from the electrical power circuit 218. In some embodiments, the battery source 122 may be charged by or using electrical power of the electrical power circuit 218.

As shown in FIG. 2, the compressor system 106 may include the compressor 226, a turbo charger 227, and an expander 228. The compressor 226 may receive air input (e.g., downstream from the air filter 230) and compress the air to supply pressurized, and correspondingly heated, air to the cathode catalyst 216. The turbo charger 227 may be configured to use or leverage energy from the flow of exhaust gases from the system 100 to drive the compressor 226 (e.g., together with the battery source 122). The expander 228 may be configured to recover some of the energy from the pressurized gas. The cathode loop 110 may include a bypass valve 232, to divert air from the compressor 226 to the expander 228 (e.g., bypassing the cathode catalyst 216). In some embodiments, the flow control valves 208(4), 208(5) may divert air from the compressor 226 (e.g., received first by the cathode catalyst 216) to the expander 228 through the reformer 206.

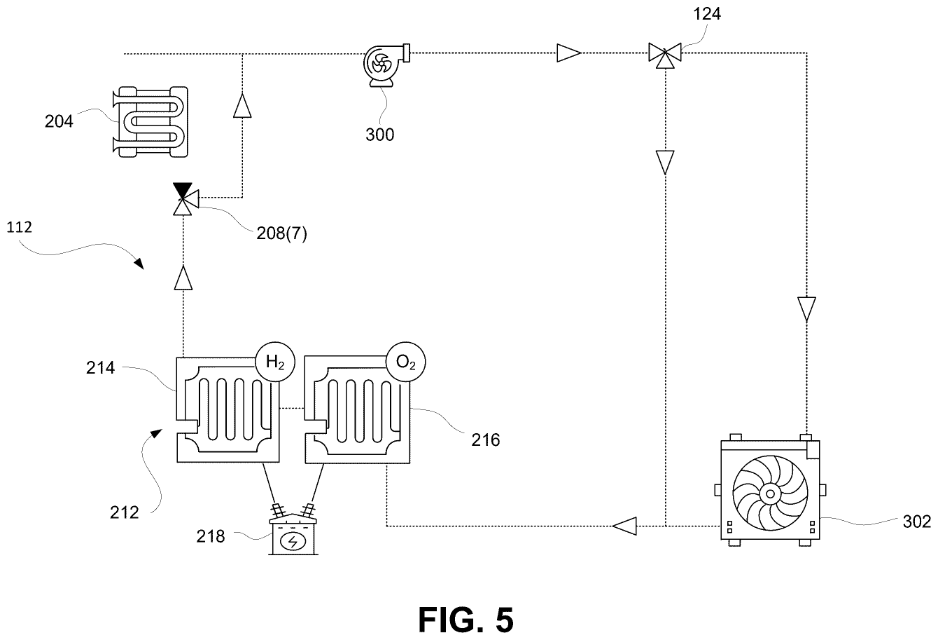

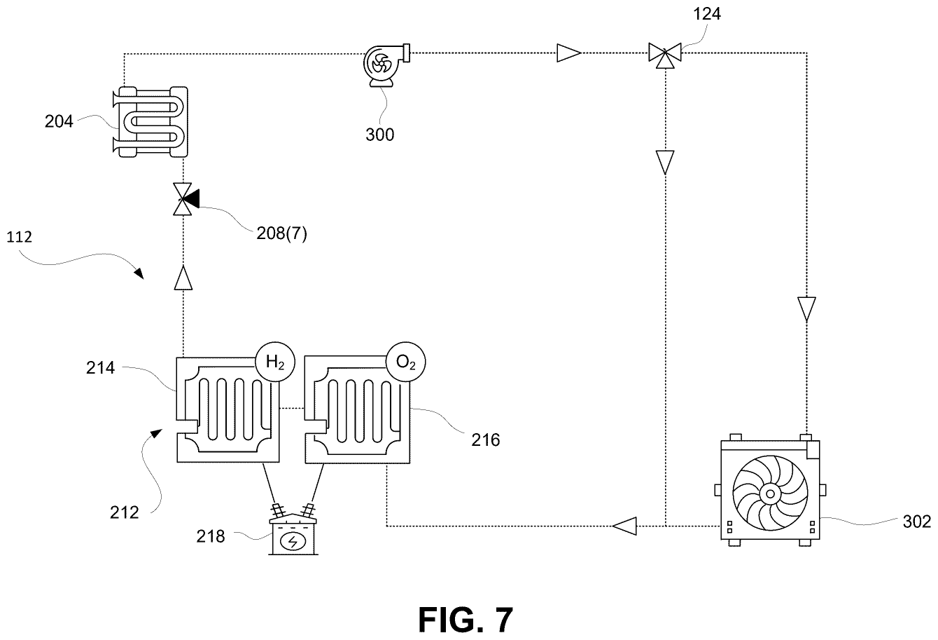

Referring now to FIG. 1 and FIG. 3, the fuel cell system 104 may include the HV and coolant circuit 112. More specifically, FIG. 3 is a schematic diagram of the HV and coolant circuit 112 of the fuel cell system 104, according to an embodiment of the present disclosure. The HV and coolant circuit 112 may include a pump 300 for pumping coolant through the coolant circuit 112. For example, the pump 300 may pump high temperature coolant through the PEM 212. Additionally, the HV and coolant circuit 112 may include the vaporizer 204 such that the HV and coolant circuit 112 may be heated by excess heat produced by the vaporizer 204. In some embodiments, the HV and coolant circuit may include a flow control valve 208(7) configured to direct the flow of coolant to the vaporizer 204, when the fuel cell system 104 uses a methanol fuel (e.g., as shown in FIG. 7), and/or around the vaporizer 204 when the fuel cell system 104 uses only pure hydrogen as fuel (e.g., as shown in FIG. 5).

As shown in FIG. 3, the HV and coolant circuit 112 may include a heat exchanger 302. The heat exchanger 302 may be configured to transfer absorbed heat from the coolant to an external fluid (e.g., air or some other cooling medium) to dissipate heat, and/or preheat incoming coolant. The HV and coolant circuit 112 may include one or more sensor(s) 124 arranged to measure, detect, or otherwise quantify a temperature of coolant of the HV and coolant circuit 112. In some embodiments, the sensor(s) 124 may be or include temperature sensors arranged to measure the temperature of the coolant. For example, the sensor(s) 124 may be a thermostat, which may include a valve for controlling the flow of coolant to the heat exchanger 302.

Referring now to FIG. 4, the anode loop 108 and the cathode loop 110 of the fuel cell system 104 are shown in a pure hydrogen mode. The pure hydrogen mode refers to an operation of the fuel cell system 104 using a pure hydrogen fuel source. For example, in the pure hydrogen mode, fuel stored in the second storage 200(b) may be supplied to the anode loop 108 of the fuel cell system 104, as opposed to fuel stored in the first storage 200(a). In this way, the flow control valve 208(1) may be in an open position such that the fuel stored in the second storage 200(b) may be provided to the pressure regulator 210 and then into the anode loop 108, as described herein.

As shown in FIG. 4, when the fuel cell system 104 is operated in the pure hydrogen mode, there is no flow through the fuel pump 202, the vaporizer 204, the reformer 206, or the catalytic converter 224. Therefore, the flow control valve 208(3) may be configured to direct excess hydrogen from the anode catalyst 214 to the hydrogen compressor 220 and the exhaust valve 222, and not to the catalytic converter 224. Similarly, the flow control valve 208(5) may be configured to direct excess oxygen from the cathode catalyst 216 to the flow control valve 208(6), rather than to the flow control valve 208(4) (which is used to direct the excess air to the catalytic converter 224 in the methanol mode and in the dual input mode, as described with reference to FIGS. 6 and 8, respectively). The flow control valve 208(6) may be configured to direct the excess oxygen to the compressor system 106.

Referring now to FIG. 5, the HV and coolant circuit 112 of the fuel cell system 104 is shown in the pure hydrogen mode. As described above, the pure hydrogen mode may not utilize the vaporizer 204. As such, the flow control valve 208(7) may be configured to direct the flow of coolant from the PEM 212 around the vaporizer 204 directly to the pump 300.

Referring now to FIG. 6, the anode loop 108 and the cathode loop 110 of the fuel cell system 104 are shown in a methanol mode. The methanol mode refers to an operation of the fuel cell system 104 using a methanol fuel source. For example, in the methanol mode, fuel stored in the first storage 200(a) may be supplied to the anode loop 108 of the fuel cell system 104, as opposed to fuel stored in the second storage 200(b). In this way, the flow control valve 208(1) may be in a closed position such that the fuel stored in the second storage 200(b) is not supplied to the anode loop 108.

As shown in FIG. 6, when the fuel cell system 104 is operated in the methanol mode, there is no path through the hydrogen compressor 220 or the exhaust valve 222. Rather, excess hydrogen from the anode catalyst 214 is received by the catalytic converter 224. Therefore, the flow control valve 208(3) may be configured to direct the excess hydrogen from the anode catalyst 214 directly to the catalytic converter 224, rather than to the hydrogen compressor 220 and the exhaust valve 222. As such, the flow control valve 208(2) may be closed off relative to the hydrogen compressor 220, such that the only path through the flow control valve 208(2) is from the pressure regulator 210 directly to the anode catalyst 214. Although the pressure regulator 210 may not receive hydrogen fuel from the second storge 200(b) in the methanol mode, the flow control valve 208(1) may be configured to direct hydrogen produced by the reformer 206 (e.g., from the methanol fuel supplied by the first storage 200(a)) to the pressure regulator 210. The pressure regulator 210 may then supply hydrogen to the anode catalyst 214 through the flow control valve 208(2).

In the methanol mode, the flow control valve 208(5) may be configured to direct exhaust from the cathode catalyst 216 to the flow control valve 208(4), rather than to the flow control valve 208(6). The flow control valve 208(4) is then used to route the exhaust from the cathode catalyst 216 to the catalytic converter 224 and/or around the catalytic converter 224 (e.g., directly to the reformer 206). The flow control valve 208(6), however, may be configured to direct excess heat produced by the reformer 206 to the expander 228 of the compressor system 106.

Referring now to FIG. 7, the HV and coolant circuit 112 of the fuel cell system 104 is shown in the methanol mode. As described above, the methanol mode utilizes the vaporizer 204, and as such, the flow control valve 208(7) may be configured to direct the flow of coolant from the PEM 212 to the pump 300 through the vaporizer 204.

Referring now to FIG. 8, the anode loop 108 and the cathode loop 110 of the fuel cell system 104 are shown in a dual input mode. The dual input mode refers to a mode of operation of the fuel cell system 104 where pure hydrogen and methanol may be used together as fuel sources. For example, the dual input mode allows for the anode loop 108 to receive fuel from the first storage 200(a) (e.g., methanol fuel) and the second storage 200(b) (e.g., hydrogen fuel). As shown in FIG. 8, the dual input mode, similar to the methanol mode, does not utilize the hydrogen compressor 220 or the exhaust valve 222 because the excess hydrogen from the anode catalyst 214 is directed to the catalytic converter 224 (e.g., using the flow control valve 208(3)). Unlike the methanol mode, however, the flow control valve 208(1) receives hydrogen from the second storage 200(b) alone, and hydrogen produced by the reformer 206 may be supplied to the anode loop 108 directly through the flow control valve 208(2), rather than through the flow control valve 208(1) and the pressure regulator 210. In this way, the pressure regulator may be configured to leverage an amount of hydrogen from the second storage 200(b) to provide to the anode loop 108 given the amount of hydrogen produced by the reformer 206. That is, the hydrogen fuel stored in the second storage 200(b) may be used to supplement an amount of hydrogen provided to the anode catalyst 214 from the reformer.

In the dual input mode, the HV and coolant circuit 112 of the fuel cell system 104 may be configured in a same manner as the HV and coolant circuit 112 of the fuel cell system 104 in the methanol mode (e.g., as shown in FIG. 7), as both modes of operation utilize the vaporizer 204.

### Industrial Applicability

The systems and methods described herein can be used in various use cases, environments, and settings, including various vehicles for supplying power to the vehicle, as a power generation system for homes or businesses (e.g., primary or back-up power), etc.

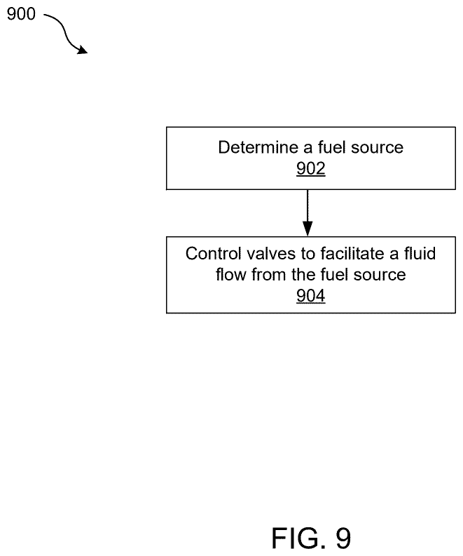

Referring now to FIG. 9, depicted is a flowchart showing an example method 900 of an operation of a dual input fuel cell, according to an example implementation of the present disclosure. The method 900 may be performed by, implemented on, or otherwise executed by the components, elements, or hardware described above with reference to FIG. 1 through FIG. 8. For example, the method 900 may be executed by the control system 102 and the fuel cell system 104 of FIG. 1. As a brief overview, at step 902, the control system 102 may determine a fuel source. At step 904, the control system 102 may control valves to facilitate a fluid flow from the fuel source.

At step 902, the control system 102 may determine a fuel source. The fuel source may be at least one of the fuel stored in the first storage 200(a) (e.g., a methanol fuel) or the fuel stored in the second storage 200(b) (e.g., pure hydrogen fuel). In some embodiments, the control system 102 may determine the fuel source by detecting a presence of fuel in the first storage 200(a) and/or detecting a presence of fuel in the second storage 200(b). For example, if the control system 102 detects a presence of fuel in the first storage 200(a), and does not detect a presence of fuel in the second storage 200(b), then the fuel source may be determined to be the methanol fuel. Similarly, if the control system 102 detects a presence of fuel in the second storage 200(b), and does not detect a presence of fuel in the first storage 200(a), then the fuel source may be determined to be the pure hydrogen fuel. If the control system 102 detects a presence of fuel in the first storage 200(a) and in the second storage 200(b), then the fuel source may be determined to be the methanol fuel and the pure hydrogen fuel. Alternatively or additionally, the control system 102 may determine the fuel source based on a received input (e.g., from an operator of the fuel cell system 104 or other user associated with the system 100). The received input may include a selection of a type of fuel among the type of fuel stored in the first storage 200(a) and the type of fuel stored in the second storage 200(b).

Based on the fuel source determined at step 902, at step 904, the control system 102 controls a plurality of valves to facilitate a fluid flow from the determined fuel source. In some embodiments, the plurality of valves may include any of the flow control valves (e.g., flow control valves 208(1)-208(7)), as described herein. For example, if the control system 102 determines the fuel source to be the first storage 200(a), the control system 102 may be configured to operate the fuel cell system 104 (and the flow control valves associated therewith) according to the methanol mode, as described above with reference to FIGS. 6-7. If the control system 102 determines the fuel source to be the second storage 200(b), the control system 102 may be configured to operate the fuel cell system 104 (and the flow control valves associated therewith) according to the pure hydrogen mode, as described above with reference to FIGS. 4-5. Alternatively or additionally, if the control system 102 determines the fuel source to be the first storage 200(a) and the second storage 200(b), the control system 102 may be configured to operate the fuel cell system 104 (e.g., and the flow control valves associated therewith) according to the dual input mode, as described above with reference to FIG. 8.

Beneficially, the systems and methods described herein can improve the efficiency and power density of HT-PEM fuel cells. By using the systems and methods described herein, a turbo-charged dual input fuel cell may improve on the efficiency of operation of vehicles that employ HT-PEM fuel cells.

What is claimed is:

1. A vehicle, comprising:
a fuel cell comprising an anode loop configured to receive hydrogen;
a first storage configured to store a first type of fuel;
a second storage configured to store a second type of fuel;
a plurality of valves respectively fluidically coupled between the anode loop and at least one of the first storage or the second storage; and
a processing circuit comprising one or more processors and memory, the memory storing instructions that, when executed, cause the processing circuit to:
determine a type of fuel to be supplied to the anode loop, from the first type and the second type; and
generate one or more control signals for the plurality of valves, to control fluid flow from a respective storage of the first storage and the second storage, based on the type of fuel, to supply hydrogen to the anode loop.

2. The vehicle of claim 1, wherein the first type of fuel comprises methanol fuel and wherein the second type of fuel comprises hydrogen fuel.

3. The vehicle of claim 2, further comprising:
a reformer configured to produce hydrogen from the methanol fuel;
a vaporizer arranged between the first storage and the reformer, the vaporizer configured to vaporize the methanol fuel to supply gaseous fuel to the reformer; and
a catalytic converter arranged downstream from the fuel cell, the catalytic converter configured to recover excess hydrogen from the hydrogen used by the anode loop.

4. The vehicle of claim 2, wherein the one or more control signals for the plurality of valves facilitate the fluid flow of the methanol fuel from the first storage and prevent the fluid flow of the hydrogen fuel from the second storage.

5. The vehicle of claim 2, further comprising:
a pressure regulator configured to regulate a pressure of the hydrogen fuel;
a hydrogen compressor; and
an exhaust valve.

6. The vehicle of claim 2, wherein the one or more control signals for the plurality of valves facilitate the fluid flow of the hydrogen fuel from the second storage and prevent the fluid flow of the methanol fuel from the first storage.

7. The vehicle of claim 2, further comprising:
a reformer configured to produce hydrogen from the methanol fuel; and
a pressure regulator configured to regulate a pressure of the hydrogen fuel provided by the second storage.

8. The vehicle of claim 1, wherein the processing circuit is configured to:
determine a presence of the first type of fuel in the first storage; and
determine the type of fuel to be supplied to the anode loop as the first type of fuel based on the presence of the first type in the first storage.

9. The vehicle of claim 1, wherein the processing circuit is configured to:
receive, from a control system of the vehicle, a selection of the type of fuel to be supplied to the anode loop,
wherein the processing circuit determines the type of fuel according to the selection.

10. An energy system for a vehicle, the energy system comprising:
a fuel cell comprising an anode loop configured to receive hydrogen;
a first storage configured to store a first type of fuel;
a second storage configured to store a second type of fuel;
a plurality of valves respectively fluidically coupled between the anode loop and at least one of the first storage or the second storage; and
a processing circuit comprising one or more processors and memory, the memory storing instructions that, when executed, cause the processing circuit to:
determine a type of fuel to be supplied to the anode loop, from the first type and the second type; and
generate one or more control signals for the plurality of valves, to control fluid flow from a respective storage of the first storage and the second storage, based on the type of fuel, to supply hydrogen to the anode loop.

11. The energy system of claim 10, wherein the first type of fuel comprises methanol fuel and wherein the second type of fuel comprises hydrogen fuel.

12. The energy system of claim 11, further comprising:
a reformer configured to produce hydrogen from the methanol fuel;
a vaporizer arranged between the first storage and the reformer, the vaporizer configured to vaporize the methanol fuel to supply gaseous fuel to the reformer; and
a catalytic converter arranged downstream from the fuel cell, the catalytic converter configured to recover excess hydrogen from the hydrogen used by the anode loop.

13. The energy system of claim 11, wherein the one or more control signals for the plurality of valves facilitate the fluid flow of the methanol fuel from the first storage and prevent the fluid flow of the hydrogen fuel from the second storage.

14. The energy system of claim 11, further comprising:
a pressure regulator configured to regulate a pressure of the hydrogen fuel;
a hydrogen compressor; and
an exhaust valve.

15. The energy system of claim 11, wherein the one or more control signals for the plurality of valves facilitate the fluid flow of the hydrogen fuel from the second storage and prevent the fluid flow of the methanol fuel from the first storage.

16. The energy system of claim 11, further comprising:
a reformer configured to produce hydrogen from the methanol fuel; and
a pressure regulator configured to regulate a pressure of the hydrogen fuel.

17. The energy system of claim 10, wherein the processing circuit is configured to:
determine a presence of the first type of fuel in the first storage; and
determine the type of fuel to be supplied to the anode loop as the first type of fuel based on the presence of the first type in the first storage.

18. The energy system of claim 1, wherein the processing circuit is configured to:
receive, from a control system of the vehicle, a selection of the type of fuel to be supplied to the anode loop,
wherein the processing circuit determines the type of fuel according to the selection.

19. A method of using a first type of fuel and a second type of fuel in a fuel cell, the method comprising:
determining, by a processing circuit, a type of fuel to be supplied to an anode loop of a fuel cell from a first type of fuel stored in a first storage and a second type of fuel stored in a second storage; and
generating, by the processing circuit, one or more control signals for a plurality of valves to control fluid flow from a respective storage of the first storage and the second storage, based on the type of fuel, to supply hydrogen to the anode loop.

20. The method of claim 19, wherein the first type of fuel comprises methanol fuel and wherein the second type of fuel comprises hydrogen fuel, the method further comprising supplying, by the processing circuit using the plurality of valves, at least one of the methanol fuel to the anode loop, the hydrogen fuel to the anode loop, or the methanol fuel and the hydrogen fuel to the anode loop.
